(19) United States
(12) Patent Application Publication
(10) Pub. No.: US 2025/0201149 A1
(43) Pub. Date: Jun. 19, 2025

(54) ORIGINAL ART BEVERAGE LABEL

(71) Applicant: Dan Lyles Gallery, LLC, Piedmont, SC (US)

(72) Inventor: Daniel Lyles, Piedmont, SC (US)

(73) Assignee: Dan Lyles Gallery, LLC, Piedmont, SC (US)

(21) Appl. No.: 18/545,651

(22) Filed: Dec. 19, 2023

(51) Int. Cl. G09F 3/02

(52) U.S. Cl. CPC G09F 3/02; G09F 2003/0208; G09F 2003/0248; G09F 2003/0273

(57) ABSTRACT

A label for attaching to a wine or spirits bottle. The label defines a cut area and an original work of art that can be removed within the cut area defined by the label. Methods of offering a wine or spirits bottle are also provided wherein a bottle having a original work of art label is offered for sale to a purchaser, and when the contents have been consumed, the bottle is send to a framer, who removes the original work of art is removed, framed, and returned to the purchaser.

### BACKGROUND OF THE INVENTION

Alcoholic beverages, particularly wine and spirits, have been a source of joy, comradery, and celebration for many people over many years. The bottles that contain these beverages are typically made of glass and typically take cylindrical or rectangular shapes for the majority of the bottle, then tapering into a neck for pouring and capping the beverage.

The typical label that wraps around all or part of the bottle is completely adhered to the bottle such that the label will not come off. The types of label and adhesive are well known in the art, and there are several industry tests to ensure that the label does not prematurely come off the bottle. These tests, such as the warm water removability test and the ice bucket test, include soaking the bottle and label for a predetermined time to ensure the adhesive and label are robust enough to hold throughout the tests. As such, the label itself is typically made from a polymeric film or a high strength bleached paper, and any logo or indicia on the label is digitally printed in a highly automated process that creates thousands of finished labeled bottles in a short period of time. The current state of the art creates incentives to produce at scale though these methods and materials. The current state of the art also contemplates unique adhesives that are designed to promote ease of recycling. However, while these adhesives do have properties that dissolve the adhesive, this occurs through massive exposure to heat and/or water, which destroys the label in the process.

The art world and artists, on the other hand, suffer from scale. Original works of art, which includes original paintings, drawings, and watercolors, are typically produced individually, making them unique and special. The art world also recognizes original engravings, prints, and lithographs as original works of art as well. As defined by the U.S. Customs and Border Protection, “Original engravings, prints, and lithographs (whether ancient or modern) are classified under subheading 9702.00.0000. The expression ‘original engravings, prints, and lithographs’ means impressions produced directly, in black and white or color, of one or of several plates wholly executed by hand by the artist, irrespective of the process or of the material employed by him, but excluding any mechanical or photomechanical process. Original impressions remain in this heading even if they have been retouched. The key for this provision is that the plates (or stones) must be executed entirely by hand by the artist. From the plates (or stones) numerous prints can be produced which would all be included under subheading 9702.00.0000. The prints are usually signed and numbered, although this is not a requirement. Thus, an original print might be marked ‘Dali, 1/75.’ This would be the first of 75 prints created from the original plates (or stones). All 75 would be classified under subheading 9702.00.0000.”

Accordingly, the art world and artists have an ability to create original works of art at higher scale, yet retain the value and integrity as original works of art. However, the current state of the art in wine and spirits labeling does not teach, suggest, or remotely offer a solution for artists to expand their reach in this space.

### BRIEF SUMMARY OF THE INVENTION

The present invention is directed to a label that is suitable for application on a bottle or other container that contains any substance. According to one embodiment, the label comprises a paper layer having an inner face and an outer face, and an adhesive layer attached to the inner face of the paper layer, wherein the adhesive layer covers between 10%-40% of the paper layer, and an art layer comprising an original work of art attached to the outer face of the paper layer. The original work of art may be a painting, drawing, or an original print as defined herein.

Unlike current wine and spirit labels, that are completely adhered to the bottle, the label of the present invention defines a cut area wherein no adhesive is present. This allows for the original work of art to be cut free from the label once a purchaser enjoys the contents within the bottle, such as wine or spirits, and kept for collecting, framing, enjoyment, and more. The present invention therefore departs from the current state of the art in wine and spirit labeling to open the door for artists and the art world to connect with new audiences, expand their reach, and engage in new opportunities and partnerships while creating value for the consumers and these industries.

The original work of art as contemplated by the present invention may be created by one of several methods that create original prints, such as lithography, serigraphy, etching, woodcut, linocut, engraving, aquatint, drypoint, mezzotint, monotype, and collagraph. Other methods are also considered by the present invention.

Methods of offering a bottle containing wine or spirits is also contemplated by the present invention. In one embodiment, the method comprises offering the bottle for sale to a consumer, wherein the bottle includes a label with an original work of art attached thereto. The bottle may come with a pre-paid box or container. When the purchaser has consumed or otherwise disposed of the contents within the bottle, the purchaser sends the bottle in the provided box to a framer, who removes the original work of art from the label, frames the original art portion of the label, and returns the framed original art to the purchaser. This full-service method provides ease and value to the consumer with this unique and special label according to the present invention.

### BRIEF DESCRIPTION OF THE DRAWINGS

FIG. 1 is a label according to one embodiment of the present invention;

FIG. 2 is a label according to another embodiment of the present invention;

FIG. 3 is a bottle and label according to one embodiment of the present invention;

FIG. 4 is another view of a bottle and label according to one embodiment of the present invention;

FIG. 5 is an alternative bottle and label according to one embodiment of the present invention;

FIG. 6 is a cross sectional view of a label according to one embodiment of the present invention; and

FIG. 7 is a flowchart illustrating an exemplary offering method according to one embodiment of the present invention.

### DETAILED DESCRIPTION OF THE INVENTION

The present invention relates to a beverage label, such as a label for a wine or alcoholic spirits (whiskey, etc) bottle. The present invention could also relate to labels found on any other type of container that would benefit from the features and benefits of the present invention.

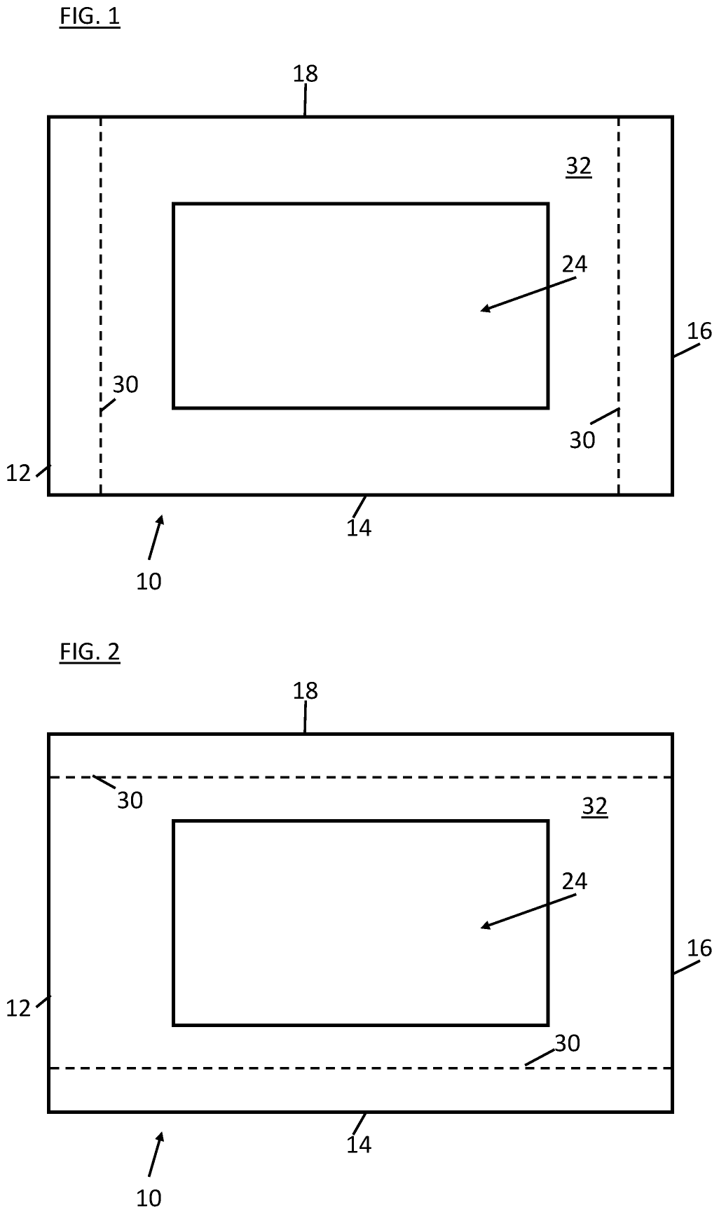

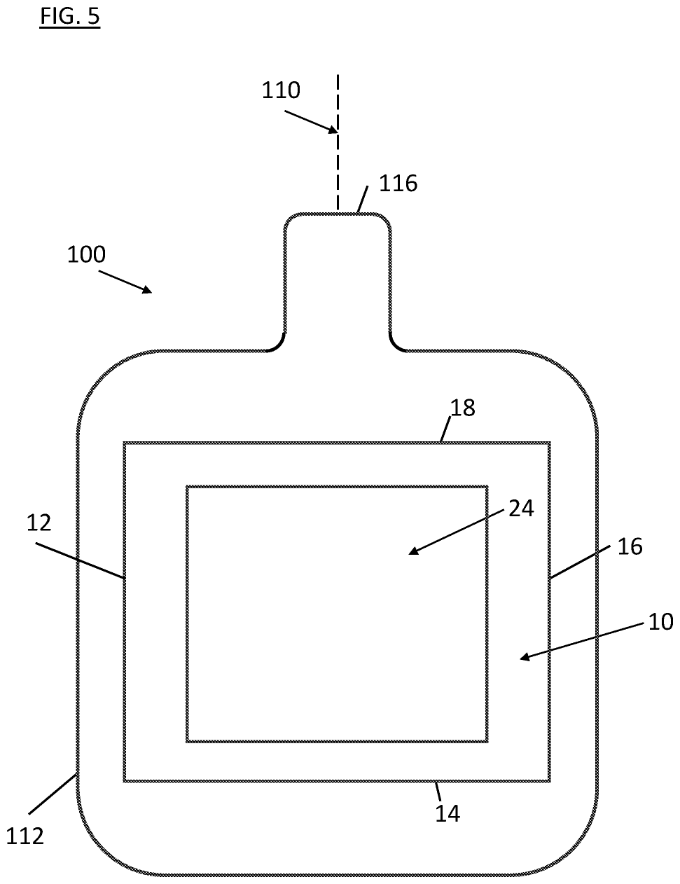

As shown in FIGS. 1-5, the present invention comprises a label 10 that can be applied to a bottle 100 having a longitudinal axis 110, wherein the label 10 wraps around the circumference of the bottle 100 around the longitudinal axis 110. In cases where a bottle is not cylindrical in nature, such as a rectangular shape shown in FIG. 5, the label can extend across one or more sides of the bottle.

More specifically, the bottle 100 can be of any shape that is compatible with having a label applied thereto. While whiskey, rum, and other spirit bottles may be generally rectangular or have squared or rounded edges, wine bottles have a generally cylindrical body 112 with a tapered neck 114. The bottle 100 defines an opening 116 at one end to dispense the contents. The sizes of wine bottles may vary, which will dictate the overall dimensions of the label 10 according to the present invention, and can hold various volumes of wine, such as 375 ml (Half a standard bottle), 750 ml (Standard bottle size), 1.5 L (Magnum), 3.0 L (Double Magnum), 4.5 L (Rehoboam), 6.0 L (Imperial), 9.0 L (Salmanazar), 12.0 L (Balthazar), and 15.0 L (Nebuchadnezzar).

The label 10 has a first side 12, second side 14, third side 16, and fourth side 18. The sides of the label 10 can be linear in nature as shown in the figures, but may also take on any other shape alone or in combination to define the overall shape of the label 10.

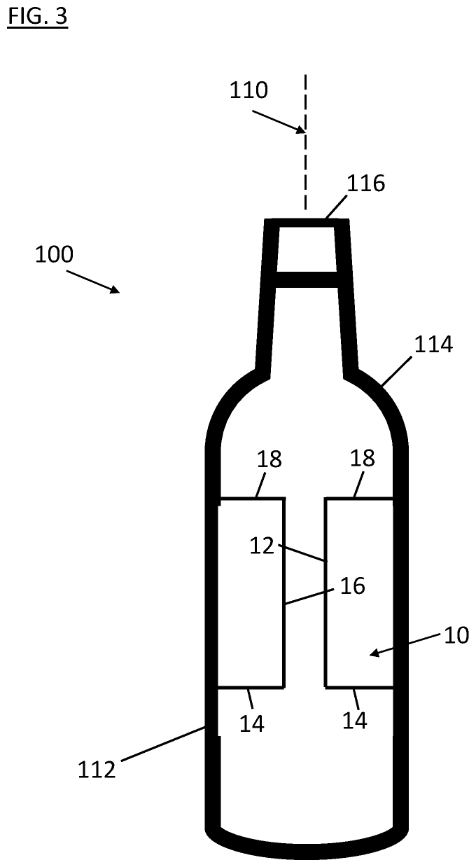

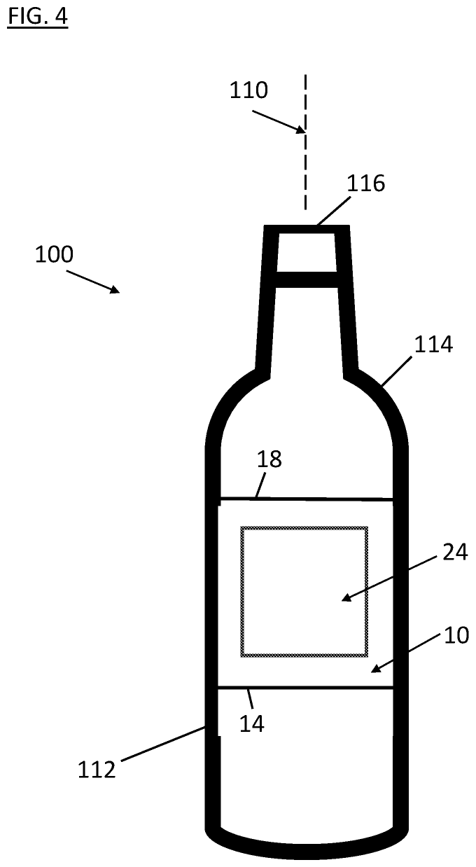

As shown in FIGS. 3-4, the label 10 is capable of wrapping around the bottle 100 such that the first side 12 and third side 16 are proximate one another. This is not required, as shown in FIG. 5, and in other embodiments of the present invention the first side 12 and third side 16 are not proximate when wrapped around the bottle 100, and in other embodiments the first side 12 and third side 16 overlap one another when wrapped around the bottle 100.

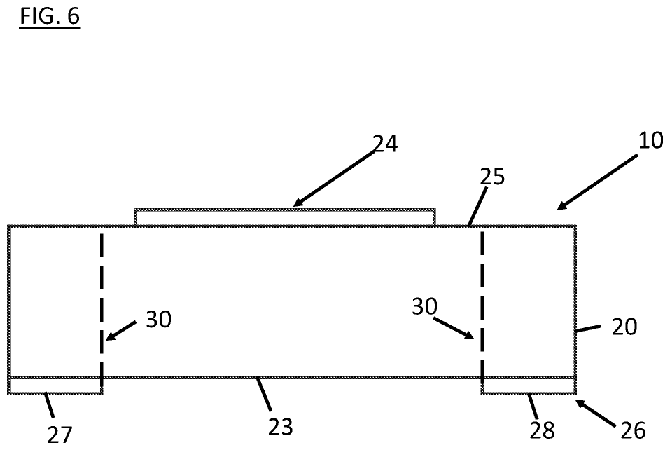

According to one embodiment shown in FIG. 6, the label 10 includes a paper layer 20 having an inner face 23 and an outer face 25, an art layer 24 applied to the outer face 25, and an adhesive layer 26. The adhesive layer 26 may be an adhesive that is known in the art, such as an acrylic pressure adhesive. Notably, the adhesive layer 26 is not applied across the entire inner face 23 of the paper layer 20. According to one embodiment, the adhesive layer 26 comprises a first strip 27 and a second strip 28 that are proximate two edges of the label 10, such as the first edge 12 and third edge 16 shown in FIG. 1, or the second edge 14 and fourth edge 18 shown in FIG. 2. The first strip 27 and second strip 28 each have an inner edge 30 that in combination define a cut area 32. It should be noted that the first strip 27 and the second strip 28 may be substantially solid strips of adhesive, or could be formed from dots or other shapes to form a generally straight or curved or wavy formation between the first edge 12, second edge 14, third edge 16, and fourth edge 18 or any combination thereof.

The total area of the label 10, and in particular the total area of the inner face 23 of the paper layer 20 covered by the adhesive layer 26, and in particular the first strip 27 and second strip 28, is preferably between 10%-40%, and more preferably 20%-30%. This is sufficient to adhere the label 10 to the bottle 100 while providing a cut area 32 of optimal size. The total area of the label 10 covered by the adhesive layer 26 may be more or less than 10%, but should be at least 2% of the total area of the label 10 and no more than 70% of the total area of the label 10.

The paper layer 24 may also include required government labeling information, such as alcohol content, color ingredient disclosures, country of origin, health warning statements, producer information, import information, net contents, and sulfite declaration. However, this information may be positioned elsewhere on the bottle, and may be on a separate label.

The paper layer 20 is preferably an art paper that is particularly advantageous for receiving an original work of art, as described herein. The paper layer 20 may be 100% cotton, or may be a combination of cotton and other materials, such as cotton and linen. The paper layer 20 may also have a neutral pH, and may be acid free. Three preferred types of paper according to the present invention are handmade paper, mould made paper, and machine made paper. In general terms, papermaking comprises the steps of separating fibers from the rest of a raw material, such as cellulose from wood or cotton; beating or mashing the fiber into a pulp; adding chemicals and other components to adjust the color, mechanical, chemical, and other characteristics; screening the resulting solution; then pressing and drying to create the finished paper product. Some common paper types and products that are contemplated by the present invention include wove paper sold by Arches, such as Arches Aquarelle, Arches, Lavis Fidelis, Velin d'Arches, Velin BFK Rives, Velin Johannot, Arches 88, Arches Expression, and Arches Platine. Other manufacturers of paper that is contemplated by the present invention include Blachet Freres & Kleber Company, Strathmore, Lana Papers, Invernesk Mill, and Awagami Factory.

The art layer 24 according to one embodiment of the present invention includes an original work of art, which includes paintings, such as oil paintings, acrylic paintings, watercolors, and original drawings, as well as original prints. Original prints are considered multiple originals. Originality is generally associated with uniqueness, but an original prints are considered original and unique because the artist originally intended to create an etching, woodcut, or other graphic work on a plate or stone using a particular technique that creates proofs printed from the plate or stone, and each proof is thereby considered original.

The production of the art layer 24 applied to the outer face 25 of the paper layer 20 may include one or more printmaking techniques that create original works of art, and more specifically original prints. As noted herein, the original print hold greater value than a mass produced, digital replica of an original work of art, as the original print is distinguishable from a reproduction because of the artist's direct involvement with the printmaking process, making it a unique work. Accordingly, printmaking techniques that result in original prints include but are not limited to lithography, serigraphy, etching, woodcut, linocut, engraving, aquatint, drypoint, mezzotint, monotype, and collagraph. In one embodiment, giclee printmaking techniques can also be used. In one embodiment, the original print is hand signed by the artist. In another embodiment, the artist associated with the original work of art applies his or her signature in the print matrix before the printmaking process. In one embodiment, the artist numbers each print as a limited edition. In one embodiment, a certificate of authenticity is included with the label 10. In one embodiment, the artist applies additional colors after the printmaking to create unique variations in the finished prints.

The original work of art comprising the art layer 24 as described herein is positioned inside the cut area 32 defined by the first strip 27 and second strip 28 of the adhesive layer 26. Accordingly, there is no adhesive under the art layer 24. As described herein, the original work of art comprising the art layer 24 may be removed and kept as a remembrance, investment, or added to a collection. As described herein, the cut area 32 is defined by the adhesive layer 26 and more specifically the placement of the adhesive strips 27 and 28 against the inner face 23 of the paper layer 20. The adhesive strips 27 and 28 thus can be positioned to account for the shape of the original work of art comprising the art layer 24. As such, the adhesive layer 26 may not comprise strips, but any other shape or combination of shapes to define a cut area such that the art layer 24 and paper layer 20 can be cut from the bottle 100 with no adhesive or de minimis adhesive attached inner face 23 of the paper layer 20.

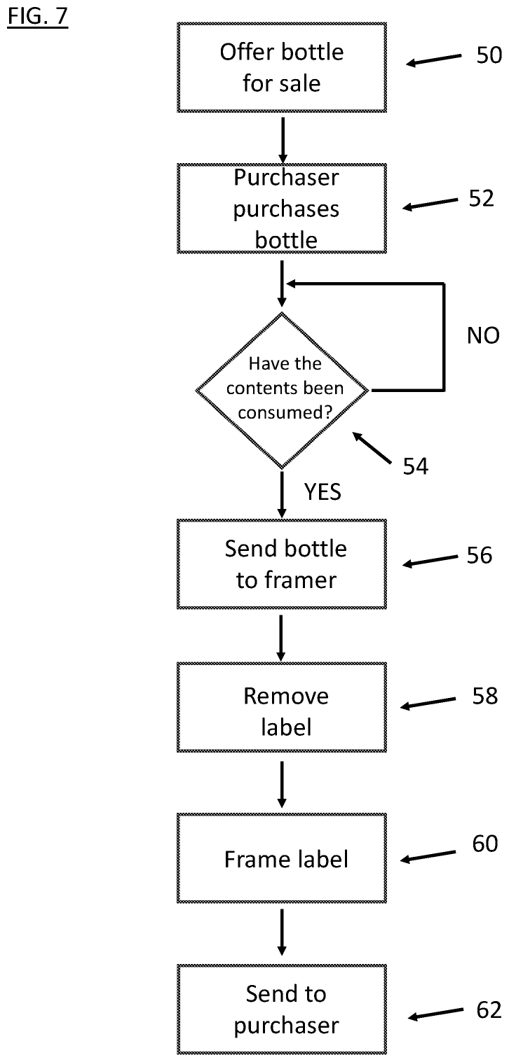

The present invention also contemplates a method of selling an original work of art using the unique label and bottle as described herein. As shown in FIG. 7, the method according to one embodiment of the present invention includes offering for sale a bottle of alcohol (step 50) to a purchaser, including wine and spirits, wherein the bottle includes a label having a paper layer, adhesive layer defining a cut area, and an original work of art applied to the paper layer. The method also comprises a purchasing step 52 where the bottle is purchased, and when the contents of the bottle have been consumed or removed from the bottle (step 54), the bottle is sent to a framer (step 56). This step can be made more convenient to the purchaser by providing a pre-paid label and box for the bottle, so when the purchaser has emptied the contents of the bottle, the purchaser can easily send the bottle to the framer. The framer then receives the bottle and removes the original work of art and the paper layer (step 58) from the bottle as defined by the cut area, meaning the framer cuts along the boundaries of the cut area or some portion therein to remove the original work of art, and then frames the original work of art (step 60). Once the framing is completed, the framer returns the framed original work of art to the purchaser (step 62).

The label according to the present invention is not taught or suggested by the digital, mass produced labels in the art, and creates a new, unique, and scalable opportunity for artists to expand their reach and promote their art in new mediums.

One skilled in the art will realize the present invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range equivalency of the claims are thereof intended to be embraced therein.

1. A glass bottle for use with alcoholic beverages, the bottle comprising:
a body defining an opening along a longitudinal axis of the body; and
label attached to the body, the label consisting of a paper layer having an inner face and outer face, and an adhesive layer attached to the inner face of the paper layer, wherein the adhesive layer covers between 10%-40% of the paper layer.

2. The bottle of claim 1, wherein the adhesive layer covers between 20%-30% of the paper layer.

3. The bottle of claim 1, wherein the adhesive layer defines a cut area wherein the adhesive layer is not attached to the paper layer.

4. The bottle of claim 3, wherein the adhesive layer includes a first strip and a second strip spaced away from the first strip, and the cut area is located between the first strip and the second strip.

5. The bottle of claim 1, wherein the paper layer includes a first edge, a second edge, a third edge, and a fourth edge, and the adhesive layer includes a first strip adjacent the first edge and a second strip adjacent the third edge defining a cut area between the first strip and the second strip, the cut area being 60%-90% of the total area of the paper layer.

6. The bottle of claim 1, wherein the paper layer includes a first edge, a second edge, a third edge, and a fourth edge, and the adhesive layer includes a first strip adjacent the second edge and a second strip adjacent the fourth edge defining a cut area between the first strip and the second strip, the cut area being 60%-90% of the total area of the paper layer.

7. The bottle of claim 1, wherein the paper layer is formed from 100% cotton.

8. The bottle of claim 1, wherein the paper layer is formed from 85% cotton and 15% linen.

9. A label for application on a bottle, the label comprising:
a paper layer having an inner face and outer face;
an adhesive layer attached to the inner face of the paper layer, wherein the adhesive layer covers between 2%-70% of the paper layer; and
an art layer comprising an original work of art attached to the outer face of the paper layer, the original work of art selected from the group consisting of paintings, drawings, and original prints.

10. The label according to claim 9, wherein the original work of art is an original print created by lithography printmaking techniques.

11. The label according to claim 9, wherein the original work of art is an original print created by serigraphy printmaking techniques.

12. The label according to claim 9, wherein the original work of art is an original print created by etching printmaking techniques.

13. The label according to claim 9, wherein the original work of art is an original print created by woodcut printmaking techniques.

14. The label according to claim 9, wherein the original work of art is an original print created by linocut printmaking techniques.

15. The label according to claim 9, wherein the original work of art is an original print created by engraving printmaking techniques.

16. The label according to claim 9, wherein the original work of art is an original print created by aquatint printmaking techniques.

17. The label according to claim 9, wherein the original work of art is an original print created by drypoint printmaking techniques.

18. The label according to claim 9, wherein the original work of art is an original print created by mezzotint printmaking techniques.

19. The label according to claim 9, wherein the original work of art is an original print created by monotype printmaking techniques.

20. The label according to claim 9, wherein the original work of art is an original print created by collagraph printmaking techniques.

21. The label according to claim 9, wherein the original work of art is an original print created by giclee printmaking techniques.

22. The label according to claim 9, wherein the original work of art is an original print that is signed by an artist associated with the original work of art.

23. A method of offering for sale a bottle having an original work of art label affixed thereto, the label having a paper layer with a surface area and an adhesive layer defining a cut area wherein no adhesive is attached to the paper layer, the cut area being between 30% and 98% of the surface area of the paper layer, the method comprising:
offering the bottle for sale to a purchaser;
receiving the bottle from the purchaser;
removing the label from the bottle;
framing the label inside of a frame; and
sending the framed label to the purchaser.

24. The method according to claim 23, wherein the receiving step includes receiving the bottle in a box with a pre-paid shipping label.

25. The method according to claim 23, wherein the removing step includes cutting the label within the cut area.

26. The method according to claim 23, wherein the removing step includes cutting the label within the cut area, the cut area being between 60%-90% of the surface area of the paper layer.
